(19) United States
(12) Patent Application Publication
(10) Pub. No.: US 2005/0254828 A1
(43) Pub. Date: Nov. 17, 2005

(54) Optical signal receiving unti and apparatus for reproducing information

(75) Inventors: Johannes Hubertus Antonius Brekelmans, Eindhoven (NL); Gerben Willem De Jong, Eindhoven (NL); Josef Reinerus Maria Bergervoet, Eindhoven (NL); Christinus Antoinetta Paulus Van Liempd, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklike Philips Electronics N.C.

(21) Appl. No.: 10/520,228

(22) PCT Filed: Jul. 1, 2003
(86) PCT No.: PCT/IB03/02993

§ 371 Date: Jan. 3, 2005

(30) Foreign Application Priority Data
Jul. 4, 2002 (EP) 020776951

(51) Int. Cl. H04B 10/06

(52) U.S. Cl. 398/202

(57) ABSTRACT

The optical signal receiving unit (10), which receives and processes an optical signal, can be programmed by the optical signal. The optical signal is detected by an optical sensor (20) and processed by a signal processor (40). The signal processor (40) has an operating mode, which is set by a programmable control unit (30). The control unit (30) is programmable by a program signal derived from the optical signal. In one embodiment the optical signal receiving unit (10) can be switched between two operating modes by a program switch signal provided at a program switch terminal (53). The apparatus (100) for reproducing information from an optical data carrier (101) comprises an optical signal receiving unit (10) according to the invention.

The invention relates to an optical signal receiving unit comprising an optical sensor for receiving optical signals, control means for providing a control signal, and a signal processor for processing the optical signal to produce a processed signal, the signal processor having an operating mode set by the control signal.

The invention also relates to an apparatus for reproducing information from an optical data carrier comprising such an optical signal receiving unit.

The data sheet of the photodiode and amplifier IC for CD and DVD applications TZA1045 by Philips Semiconductor discloses an embodiment of an optical signal receiving unit as described in the opening paragraph. The IC comprises a photodiode, which is used as an optical sensor for receiving an optical signal generated by a light source such as, e.g., a laser, irradiating an optical data carrier such as, e.g., a CD disc or DVD disc. The optical signal received by the photodiode is processed by a signal processor which comprises a set of amplifiers integrated in the IC. The processed signal is provided at the output terminal for further processing, e.g., in an apparatus comprising the optical signal receiving unit such as, e.g., a CD player or a DVD player.

At present many apparatus such as CD players and DVD players are capable to reproduce information from and to record information on a data carrier. These applications are referred to as reading and writing, respectively. For writing it is often required to monitor the light beam reflected by the optical data carrier to assure that the information is being recorded with the appropriate intensity and on the correct portion of the data carrier. The light may be monitored by the optical signal receiving unit. For each application such as, e.g., reading a CD disc, writing a CD disc, reading a DVD disc and writing a DVD disc, the signal processor has an operating mode specific for the application. The operating mode comprises amongst others a set of amplification factors for the set of amplifiers, which are specific for the application.

The operating mode is set by a control signal, which is provided by control means. In the known optical signal receiving unit this control means comprises three control terminals, which receive a digital signal and provide it to a decoder. The digital signal may be provided by, e.g. a system control means of the apparatus comprising the optical signal receiving unit. Depending on the digital signal the decoder provides a corresponding set of voltages determining the set of amplification factors. Because the control means comprises three binary control terminals, a maximum of 2³, i.e. eight, different operating states can be distinguished.

It is a disadvantage of the known optical signal receiving unit that the number of operation modes, which can be set by the control means, is limited by the number of control terminals. The number of applications each requiring an application specific operating mode is growing and therefore, there is a need to be able to switch between an increasing number of operation modes.

It is an object of the invention to provide an optical signal receiving unit of the kind described in the opening paragraph in which the number of operation modes, which can be set by the control means, is independent of the number of control terminals.

The invention is defined by the independent claims. The dependent claims define advantageous embodiments.

According to the invention the optical sensor is arranged for receiving an optical signal, which comprises an optical program signal, and the control signal is dependent on the optical program signal. The information required for setting the operating mode is transferred to the optical signal receiving unit via light detected by the optical sensor. The number of operation modes is then determined by the optical program signal and not by the number of control terminals.

In U.S. Pat. No. 4,626,848 a reconfigurable remote control is disclosed that has the ability to learn, store and repeat the remote control codes from any other infrared transmitter. The reconfigurable remote control transmitter includes an infrared receiver, a microprocessor, nonvolatile and scratch pad random access memories, and an infrared transmitter. The microprocessor application is divided into four main categories: learning storing, retransmitting, and user interface. In the learning process, the reconfigurable remote transmitter receives and decodes the transmissions from another remote control transmitter. The process is repeated at least twice for each key to make sure that it has been properly received and decoded. Once the data has been received and decoded it is stored for latter use. When the learning and storing operations have been completed, the reconfigurable remote control is ready to use as a remote control. However, it is not suited to be used as an optical signal receiving unit.

In an embodiment the optical signal receiving unit further comprises a program control terminal for receiving a program control signal enabling the control means to be programmed by a program signal derived from the optical signal. By providing a program control signal such as, e.g., a voltage corresponding to a first digital condition, e.g., to the high condition, at the program control terminal, the control means is set in a program mode. In this mode the information required for setting the operating mode and comprised in the program mode is transferred to the optical signal receiving unit via light detected by the optical sensor. In an embodiment the control signal is obtained from the program signal by integrating the optical signal over the period of time, in which the program control signal is present.

In another embodiment, the program control terminal is omitted and the optical signal receiving unit further comprises program signal detection means for detecting the optical program signal and for deriving a program signal from it. The optical program signal may be composed of a signal in a predefined frequency band, which is preferably substantially free from the optical information signal in order to reduce the chance of erroneously interchanging the optical program signal and the optical information signal when programming the control means. In this case the program signal detection means may be, e.g., a band pass filter arranged to transmit the optical signal within this predefined frequency band to the control means while suppressing the optical signal outside this predetermined frequency band. Thus, the program signal detection means discriminates the optical program signal from the optical information signal based on the frequency of these two signals.

In a variation of this embodiment the optical program signal and the optical information signal have an optical program amplitude and an optical information amplitude, respectively, the optical program amplitude being different from the optical information amplitude. Here, amplitude refers to the intensity of the two signals. The program signal detection means is an amplitude filter arranged to transmit the optical signal having the optical program amplitude while suppressing the optical signal having the optical information amplitude. Thus, the program signal detection means discriminates the optical program signal from the optical information signal based on the amplitudes of these two signals.

Alternatively, or in addition, the two signals may be discriminated based on different wavelengths. To this end, the wavelength of the light source may be varied, resulting in a varying optical signal due to, e.g., a wavelength dependent sensitivity of the optical sensor. Alternatively, the program signal may be encoded in the optical signal by the optical data carrier irradiated by the light source.

The optical signal may be processed by the signal processor before it is used as program signal.

The discriminated optical program signal may then be used to derive the program signal is a way similar to the embodiment having a program control terminal.

It is advantageous if the control means comprises a first decoder for decoding the program signal and providing a decoded program signal. For a reliable programming it is advantageous if the program signal is encoded in the optical signal, e.g., by varying the light intensity of a light source used for generating the optical signal such as, e.g., switching the light source on and off resulting in a pulsed signal. In this case a first, e.g. digital, decoder may be used to derive the control signal from the program signal.

It is advantageous if the first decoder comprises a pulse counter. This is an economic means for decoding a pulsed signal. Alternatively, the first decoder may comprise a synchronous receiver, which is provided with a clock signal also provided to the light source for modulating the optical signal.

It is advantageous if the control means further comprise a memory device for storing and providing the decoded program signal. It is economic to program the control means only when it is necessary to change the operating mode. This requires storing the decoded program signal in a memory device. Alternatively, the program signal may be continuously encoded in the optical signal.

It is advantageous if the memory device comprises a latch. This is an economic means for storing the decoded program signal. The content of the latch may be directly proportional to the control signal, e.g., to the amplification factor. Alternatively, the memory device may comprise a random access memory, which is capable of storing a complex program signal.

It is advantageous if the control means further comprises a second decoder for further decoding the decoded program signal provided by the memory device and for providing the control signal. In many cases the decoded program signal provided by the memory device is not directly proportional to the control signal. The control signal may comprise information about, e.g., the amplification factors of various amplifiers in the signal processor. For a more economic storage of this information it may be advantageous not to store the control signal itself, e.g. all the amplification factors individually, but to store a simpler digital code, which comprises the control signal after being decoded by the second decoder.

It is advantageous if the optical sensor comprises a first detector for providing the optical signal to the signal processor and a second detector for providing the program signal, which is derived from the optical signal, to the control means. The signal provided by the second detector may be processed, e.g. amplified, before it is used as the program signal.

When the optical signal receiving unit is used in an apparatus for reproducing information from an optical data carrier such as, e.g., a CD player or a DVD player, a light source such as, e.g., a laser is used for irradiating the data carrier, e.g. a CD disc or a DVD disc, to generate an optical signal comprising the information from the optical data carrier. This optical signal is detected by the first detector, processed by the signal processor and provided at the output terminal.

For programming the control means it is often advantageous if the optical signal, which is used to derive the program signal, is not detected after being reflected or transmitted by the optical data carrier because this may disturb the programming. Therefore, the second detector is used, which preferably detects the optical signal not having interacted with the optical data carrier. In an apparatus for reproducing information from an optical data carrier this may be achieved by directly exposing the second detector to light generated by the light source.

It is advantageous if the optical signal receiving unit further comprises a monitor terminal for monitoring the program signal. Thereby it is possible to monitor the programming of the control means and to repeat the programming in case the monitored program signal does not correspond to the generated optical signal.

It is advantageous if the optical signal receiving unit having a memory device has a control means, which is able to provide a first control signal and a second control signal, furthermore a signal processor, which has a first operating mode set by the first control signal and a second operating mode set by the second control signal, and a program switch terminal for receiving a program switch signal enabling the control means to switch between the first control signal and the second control signal.

In another embodiment the optical program signal comprises a power down signal, the signal processor has a power down operating mode in which the signal processor is switched off, the power down operating mode being set by the control means when the control signal depends on the power down signal. In this case the power consumption is relatively small which is particularly advantageous in, e.g. mobile applications during periods in which the optical signal receiving unit is not used and the signal processor is switched off.

In one embodiment the power down signal is given by an optical signal with an intensity integrated over a predefined period of time period, which integrated intensity is smaller than a predefined integrated intensity. In another embodiment the power down signal is given by a predefined pulse sequence.

This optical signal receiving unit may be used in an apparatus for reproducing information from and recording information on an optical data carrier, such as, e.g., a CD recorder or a DVD recorder. The processes of reproducing information and of recording information are referred to as reading and writing, respectively. For reading and writing the light source of the apparatus is generating light of different intensity and the signal processor of the optical signal receiving unit is operated in different operating modes. It is advantageous if programming the control means every time the apparatus is switched from reading to writing or vice versa can be avoided. To this end the control signal required for reading and the control signal required for writing are stored in the memory device.

When a first program switch signal is provided at the program switch terminal, the control means provides the control signal required for reading. When a second program switch signal is provided at the program switch terminal, the control means provides the control signal required for writing. The first program switch signal and the second program switch signal may be, e.g., a relatively high voltage and a relatively low voltage, respectively.

Alternatively, switching between two or more operating states may be advantageous in an apparatus equipped with light sources operating at different wave lengths, when the application requires frequent switching between the light sources.

It is advantageous if the optical signal receiving unit is able to receive an optical signal, which comprises an optical information signal generated by the light source and the data carrier, and an optical program signal generated by the light source, and the optical sensor comprises a first detector for receiving the optical information signal and for providing the optical information signal to the signal processor, and a second detector for receiving the optical program signal and for providing the optical program signal to the control means.

These and other aspects of the optical signal receiving unit and the apparatus according to the invention will be further elucidated and described with reference to the drawings, in which:

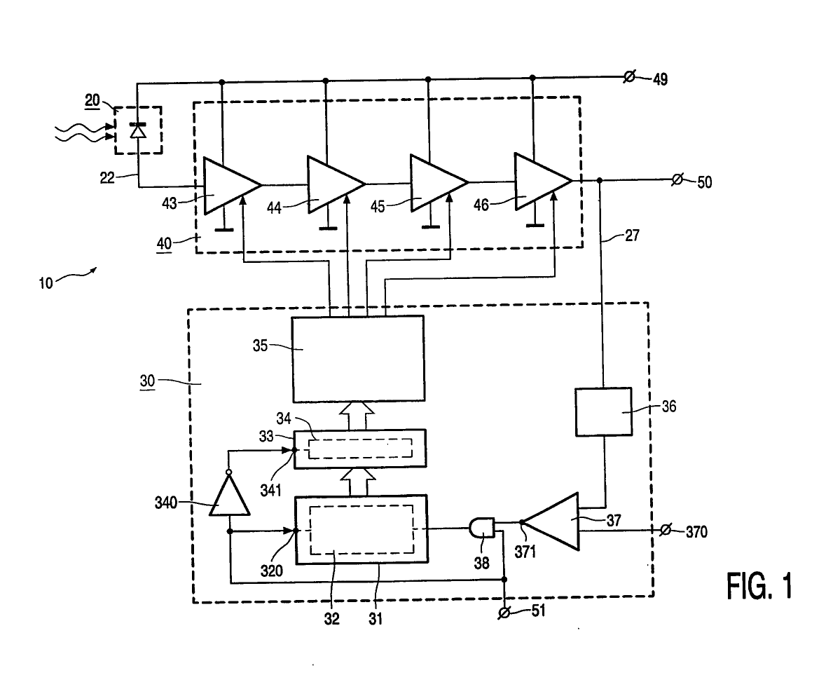

FIG. 1 is a schematic drawing of a first embodiment of the optical signal receiving unit,

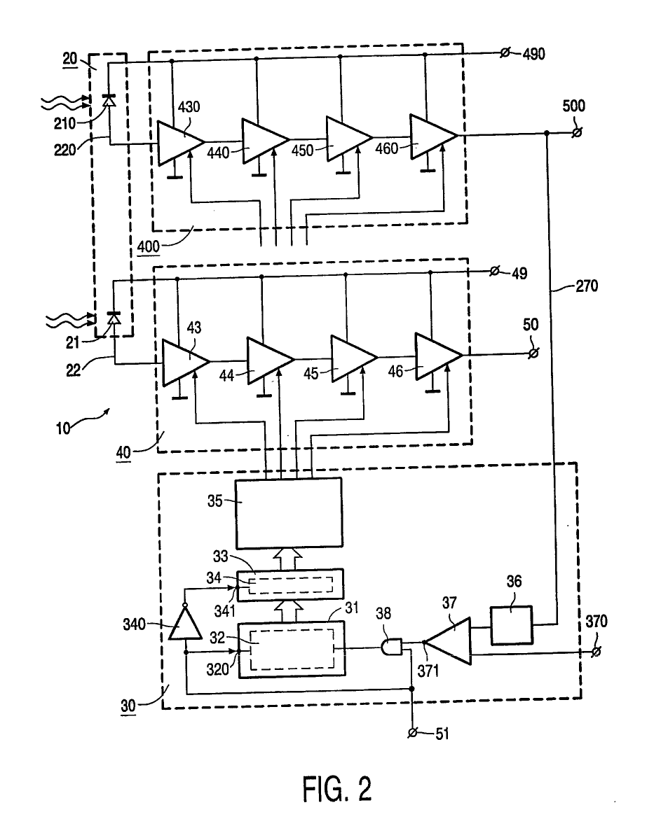

FIG. 2 is a schematic drawing of a second embodiment of the optical signal receiving unit,

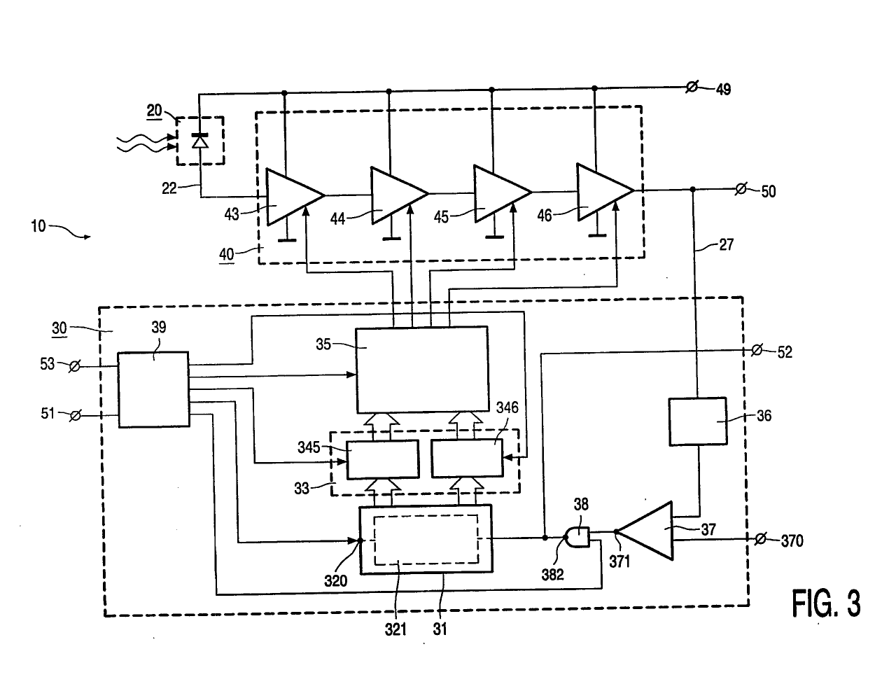

FIG. 3 is a schematic drawing of a third embodiment of the optical signal receiving unit,

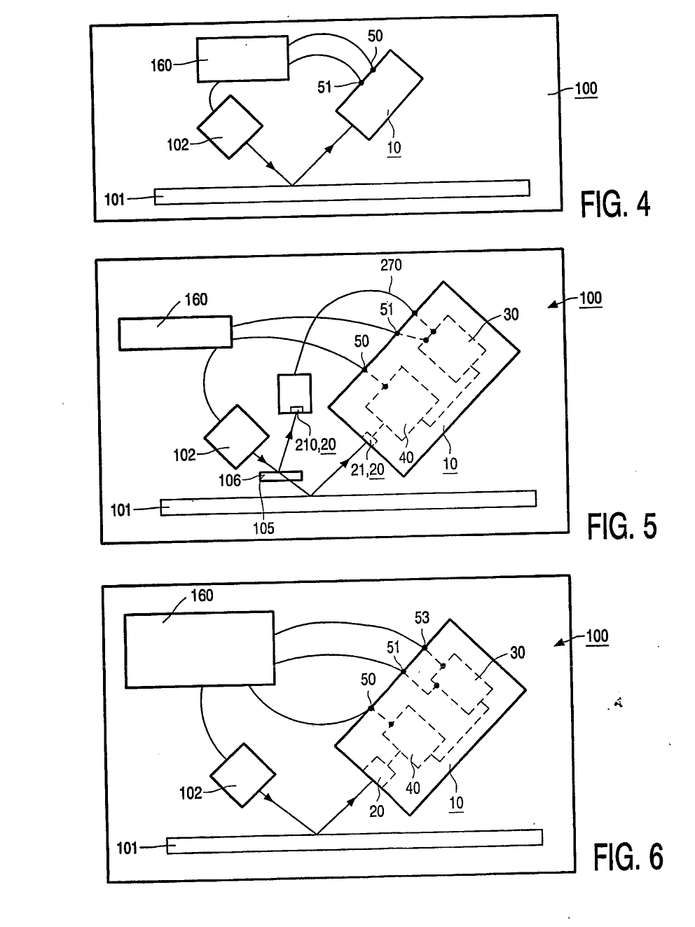

FIG. 4 is a schematic drawing of a first embodiment of the apparatus for reproducing information from an optical data carrier,

FIG. 5 is a schematic drawing of a second embodiment of the apparatus for reproducing information from an optical data carrier, and

FIG. 6 is a schematic drawing of a third embodiment of the apparatus for reproducing information from an optical data carrier.

In the Figures, like reference numerals refer to like parts.

The optical signal receiving unit 10, shown in FIG. 1, has an optical sensor 20, which in the embodiment of FIG. 1 comprises a photodiode. The optical sensor 20 provides the optical signal via electrical lead 22 to the signal processor 40. The signal processor 40 comprises a sequence of amplifiers 43, 44, 45 and 46, which amplify the optical signal to produce a processed signal having an amplitude suitable for transportation and further processing. The signal processor 40 and the optical sensor 20 are integrated in the same IC. In another embodiment not shown the optical sensor 20 is integrated in a first IC and the signal processor 40 is integrated in a second IC.

The signal processor 40 has an operating mode, which is given amongst others by the amplification factors of the amplifiers 43, 44, 45 and 46. The amplification factors are determined by control signals provided by a control unit 30. The signal processor 40 provides the processed signal at the output terminal 50. The optical sensor 20 and the amplifiers 43, 44, 45 and 46 are provided with electrical power via power terminal 49.

The control unit 30 is programmable by a program signal, which is derived from the processed signal and provided to the control unit 30 via electrical lead 27.

In another embodiment not shown the optical signal provided by the optical sensor 20 is provided directly to the control unit 30.

The optical signal receiving unit 10 further comprises a program control terminal 51, which enables the control unit 30 to be programmed. During normal operation, when the optical signal receiving unit 10 is used for receiving an optical signal to be provided at the output terminal 50, the program control terminal 51 is provided with a program control signal, which is a relatively low voltage, for example between 0 and 1 V.

When the control unit 30 is to be programmed, the program control terminal 51 is provided with a program control signal, which is a relatively high voltage, for example preferably between 4 and 5.5 V. Upon the change of the program control signal from the relatively low voltage to the relatively high voltage, a pulse counter 32, which is part of a first decoder 31 for decoding the program signal, is reset. The reset is triggered by the edge of the program control signal provided at the reset terminal 320.

After the program control signal is switched to the relatively high voltage, the optical sensor 20 is to be provided with a pulsed light signal. The corresponding optical signal is processed by the signal processor 40 and provided as the program signal to the control unit 30 by electrical lead 27. In the embodiment shown in FIG. 1 the operating mode during programming is equal to the operating mode last used before programming. In another embodiment not shown the program control signal is provided as control signal to the signal processor 40 during programming.

In the control unit 30 the program signal is first filtered by a low pass filter 36. In another embodiment, not shown, the filter 36 comprises a combination of a low pass filter and a high pass filter, in yet another embodiment also not shown a band pass filter is used. Alternatively, the filter 36 may be omitted. Subsequently, the voltage of the program signal after the low pass filter 36 is compared by comparator 37 to a reference voltage provided at a reference voltage terminal 370. If the voltage of the program signal is higher than the reference voltage, the comparator 37 provides the voltage of the program signal via comparator terminal 371 to a first input terminal of an AND gate 38. A second input terminal of AND gate 38 is provided with the program control signal by the program control terminal 51.

When the control unit 30 is programmed and the program control signal is a relatively high voltage, the AND gate 38 is opened by a pulse in the program signal and the pulse counter 32 is provided with one pulse. Once pulse counter 32 has been incremented to the value corresponding to the operating mode being programmed, the program signal has been decoded and the pulse counter 32 has a value, which is identical to the decoded program signal. The program control terminal 51 is then provided with a program control signal, which is a relatively low voltage, for example between 0 and 1 V. Then the pulse counter 32 does not receive any pulses anymore because the AND gate 38 is closed.

The value of the pulse counter 32 is now stored in a memory device 33, which in the first embodiment shown in FIG. 1 comprises latch 34. The latch 34 is loaded with the decoded program signal by edge triggering upon the change of the program control signal from the relatively high voltage to the relatively low voltage. Because the triggering is done on the down going edge of the program control signal, the latter signal is inverted by inverter 340 before being provided to the load terminal 341 of the latch 34.

The decoded program signal stored in latch 34 is provided to a second decoder 35, which transforms the content of the latch 34 to provide control signals to the amplifiers 43-46. In another embodiment, not shown, the optical signal receiving unit 30 further comprises a monitor terminal for monitoring the program signal provided by the AND gate 38. During programming the monitor terminal is coupled to one of the output terminals of the signal processor 40 so as to allow verification of the signals during the programming.

In a variation of this embodiment the optical signal receiving unit 10 is able to receive a power down signal for switching off the signal processor 40. To this end the electrical lead 27 comprises an additional, e.g. analogous, switch, not shown, which, depending on its switching state, is able to electrically connect electrical lead 27 to filter 36 or to an additional electrical lead, not shown. The additional electrical lead is electrically connected to the anode of a photo diode which constitutes the optical sensor 20. An additional control line electrically connects the second decoder 35 and the switch.

In the power down mode, the amplifiers 43-46 are switched off. When the photo diode of the optical sensor 20 receives an optical signal and the signal processor 40 is switched off, the voltage at the entrance of the first amplifier 43 increases to a relatively high level due to the relatively high input impedance of the amplifier 43 whereas the voltage at the entrance of the first amplifier 43 is at a relatively low level when the signal processor 40 is switched on. The relatively high voltage at the entrance of amplifier 43 is detected by the additional switch via the additional electrical lead, the filter 36ad the comparator 37. The program control terminal 51 is activated and the power down mode is switched off.

In the second embodiment shown in FIG. 2 the optical signal receiving unit 10 has an optical sensor 20, which comprises a first detector 21 for providing the optical signal via electrical lead 22 to the signal processor 40. The signal processor 40 is identical to the signal processor 40 of the first embodiment described above. The first detector 21 is a photodiode, which in another embodiment not shown comprises a central diode and eight satellite diodes. Each of these diodes provides a signal to a signal processor 40.

In contrast to the first embodiment the optical sensor 20 further comprises a second detector 210, which is a photodiode, for providing a program signal derived from the optical signal to the control unit 30. The first detector 21 and the second detector 210 are integrated in the same IC. In another embodiment not shown the first detector 21 is integrated in a first IC and the second detector 210 is integrated in a second IC.

The second detector 210 provides the optical signal via electrical lead 220 to the signal processor 400. The signal processor 400 comprises a sequence of amplifiers 430, 440, 450 and 460, which amplify the optical signal to produce a processed signal to a sufficient level. The signal processor 400 provides the processed signal at the output terminal 500 and via electrical lead 270 to the control unit 30, which is identical to the control unit 30 of the first embodiment. The signal processor 400 has an operating mode, which is given by the amplification factors of the amplifiers 430, 440, 450 and 460. The signal processor 400 and the photodiode 210 are integrated in the same IC. In another embodiment not shown the signal processor 40 and signal processor 400 are integrated in the same IC.

The amplification factors are determined by control signals from the control unit 30, the corresponding connections are not shown. The second detector 210 and the amplifiers 430, 440, 450 and 460 are provided with electrical power via a power terminal 490.

In another embodiment not shown the amplifiers 430-460 are controlled by separate control signals by a separate control unit.

In yet another embodiment also not shown the optical signal provided by the second detector 210 is provided to the control unit 30 without being processed by signal processor 400.

In the third embodiment shown in FIG. 3 the optical signal receiving unit 10 has an optical sensor 20 and a signal processor 40 as described in the first embodiment. The optical signal receiving unit 10 further comprises a monitor terminal 52 for monitoring the program signal provided by the AND gate 38.

The optical signal receiving unit 10 further comprises a program switch terminal 53 for receiving a program switch signal, which enables the control unit 30 to switch between a first control signal and a second control signal. The control unit 30 shown in FIG. 3 comprises the filter 36, the comparator 37 and the AND gate 38 used in the control unit 30 of the first embodiment. The AND gate 38 provides the program signal to the first decoder 31, which comprises a synchronous receiver 321. The synchronous receiver 321 is provided with a clock signal at a clock terminal, which is not shown.

To enable the control unit 30 to switch between a first control signal and a second control signal, the control unit 30 comprises a logic element 39 which is provided with the program control signal and the program switch signal by the program control terminal 51 and the program switch terminal 53, respectively. Analogously to the first embodiment, the program control terminal 51 is provided with a program control signal, which is a relatively low voltage, for example between 0 and 1 V during normal operation, when the optical signal receiving unit 10 is used for receiving an optical signal to be provided at the output terminal 50.

When programming of the control unit 30 starts, the program control signal provided at the program control terminal 51 is changed from a relatively low voltage, for example between 0 and 1 V, to a relatively high voltage, for example between 4 and 5.5 V. Upon the change of the program control signal the logic element 39 activates the synchronous receiver 321 to receive the program signal provided by the output terminal 382. After synchronous receiver 321 received the entire program signal, the program control signal provided at the program control terminal 51 is changed from a relatively high voltage, preferably between 4 and 5.5 V, to a relatively low voltage, for example between 0 and 1 V.

The program signal received by the synchronous receiver 321 comprises a first program signal component, in which the first control signal is encoded, and a second program signal component, in which the second control signal is encoded. The first program signal component and the second program signal component are decoded by the synchronous receiver, which provides a first decoded program signal component and a second decoded program signal component.

Upon the change of the program control signal from a relatively high voltage, for example between 4 and 5.5 V, to a relatively low voltage, for example between 0 and 1 V, the logic element 39 provides a first latch 345 and a second latch 346 of memory device 33 with a signal to load the first decoded program signal component and the second decoded program signal component, respectively. The first decoded program signal component and the second decoded program signal component are stored in the first latch 345 and the second latch 346, respectively, and provided to the second decoder 35.

When the program switch terminal 53 is provided with a program switch signal, which is a relatively high voltage, for example between 4 and 5.5 V, the logic element 39 provides the second decoder 35 with a signal enabling the second decoder 35 to provide the first control signal to the amplifiers 43-46.

When the program switch terminal 53 is provided with a program switch signal, which is a relatively low voltage, for example between 0 and 1 V, the logic element 39 provides the second decoder 35 via terminal 350 with a signal enabling the second decoder 35 to provide the second control signal to the amplifiers 43-46.

The apparatus 100 for reproducing information from an optical data carrier 101 shown in FIG. 4 comprises a light source 102, which is a semiconductor laser. The light source 102 is able to irradiate the optical data carrier 101, which is a DVD, a CD, CD-R, CD-RW etc. disc to generate an optical signal, which comprises the information to be reproduced from the optical data carrier 101.

In the first embodiment of the apparatus 100 shown in FIG. 4 the optical signal generated by the light source 102 and the optical data carrier 101 is received by the optical signal receiving unit 10 shown in FIG. 1 and described above.

The apparatus 100 further comprises a system controller 160, which may be a microprocessor. It controls the intensity of the light source 102 by switching the light source 102 on and off to provide the optical signal with the information of the program signal. The system controller 160 also provides the program control signal to the program control terminal 51 when the control unit is programmed.

During normal operation, when the optical signal receiving unit 10 is used for receiving an optical signal comprising information from the optical data carrier 101, the output terminal 50 provides the system control unit 160 with the processed signal for further processing.

In the second embodiment of the apparatus 100 shown in FIG. 5 the apparatus 100 comprises an optical signal receiving unit 10 as shown in FIG. 2. During normal operation the optical signal comprises an optical information signal, which is generated by the light source 102 and the optical data carrier 101. When the control unit 30 is programmed the optical signal comprises an optical program signal generated by switching on and off the light source 102. The switching on and off is controlled by the system control unit 160 The optical sensor 20 comprises a first detector 21, which receives the optical information signal and provides it to the signal processor 40. The optical sensor 20 further comprises a second detector 210, which is provided with the optical signal by a semi-reflecting surface of a beam splitter 106. The second detector 210 receives the optical program signal and provides it to the control unit 30 via electrical lead 270.

In the third embodiment of the apparatus 100 shown in FIG. 6 the apparatus 100 comprises an optical signal receiving unit 10 shown in FIG. 3. The apparatus 100 is a DVD recorder which is able to record information on the optical data carrier 101 which is recordable DVD disc. When the apparatus 100 records information in the optical data carrier 101, the light source 102 is operated at relatively high power. The optical signal is then processed by the signal processor 40 using a relatively low amplification factor corresponding to a first control signal. When the apparatus 100 reproduces information from the optical data carrier 101, the light source 102 is operated at relatively low power. The optical signal is then processes by the signal processor 40 using a relatively high amplification factor corresponding to a second control signal. The power of the light source 102 is controlled by the system control unit 160.

Referring to FIG. 3, the first control signal and the second control signal are stored in the first latch 345 and the second latch 346, respectively. The system control unit 160 shown in FIG. 6 is connected to the program switch terminal 53 to switch the control unit 30 between the first control signal and the second control signal.

The optical signal receiving unit 10, which receives and processes an optical signal, can be programmed by the optical signal. The optical signal is detected by an optical sensor 20 and processed by a signal processor 40. The signal processor 40 has an operating mode, which is set by a programmable control unit 30. The control unit 30 is programmable by a program signal derived from the optical signal. In one embodiment the optical signal receiving unit 10 can be switched between two operating modes by a program switch signal provided at a program switch terminal 53. The apparatus 100 for reproducing information from an optical data carrier 101 comprises an optical signal receiving unit 10 according to the invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of other elements than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. An optical signal receiving unit (10) comprising:
an optical sensor (20) for receiving optical signals including an optical information signal and an optical program signal,
control means (30) for providing a control signal in dependence on said optical program signal, and
a signal processor (40) for processing at least the optical information signal to produce a processed signal, the signal processor (40) having an operating mode set by the control signal.

2. An optical signal receiving unit (10) as claimed in claim 1, further comprising a program control terminal (51) for receiving a program control signal to enable the control means (30) to be programmed by a program signal derived from the optical program signal.

3. An optical signal receiving unit (10) as claimed in claim 1, wherein the control means (30) comprise a first decoder (31) for decoding the optical program signal to provide a decoded program signal.

4. An optical signal receiving unit (10) as claimed in claim 3, wherein the first decoder (31) comprises a pulse counter (32).

5. An optical signal receiving unit (10) as claimed in claim 3, wherein the control means (30) further comprise a memory device (33) for storing and providing the decoded program signal.

6. An optical signal receiving unit (10) as claimed in claim 5, wherein the control means (30) further comprise a second decoder (35) for further decoding the decoded program signal provided by the memory device (33) to provide the control signal.

7. An optical signal receiving unit (10) as claimed in claim 1, wherein the optical sensor (20) comprises:
a first detector (21) for providing the optical information signal to the signal processor (40), and
a second detector (210) for providing a program signal to the control means (30), the program signal being derived from the optical program signal.

8. An optical signal receiving unit (10) as claimed in claim 1, further comprising a monitor terminal (52) for monitoring the optical program signal.

9. An optical signal receiving unit (10) as claimed in claim 5, wherein:
the control means (30) is able to provide a first control signal and a second control signal as the control signal,
the signal processor (40) has a first operating mode set by the first control signal and a second operating mode set by the second control signal, and the optical signal receiving unit (10) further comprises
a program switch terminal (53) for receiving a program switch signal enabling the control means (30) to switch between the first control signal and the second control signal.

10. An apparatus (100) for reproducing information from an optical data carrier (101), the apparatus (100) comprising:
a light source (102) for irradiating the optical data carrier (101) to generate an optical signal,
an optical signal receiving unit (10) as claimed in claim 1,
system controlling means (160) for controlling the light source (102) and for further processing the processed signal.

11. An apparatus (100) as claimed in claim 10, wherein:
the optical information signal is generated by the light source (102) and the optical data carrier (101), and
the optical program signal is generated by the light source (102), and the optical sensor (20) comprises:
a first detector (21) for receiving the optical information signal and for providing the optical information signal to the signal processor (40), and
a second detector (210) for receiving the optical program signal and for providing the optical program signal to the control means (30).
